(19) United States
(12) Patent Application Publication
(10) Pub. No.: US 2017/0291257 A1
(43) Pub. Date: Oct. 12, 2017

(54) PORTABLE LASER MARKING APPARATUS

(71) Applicant: SOONMARK CO., LTD., TAICHUNG CITY (TW)

(72) Inventors: CHIEH HUANG CHANG, TAICHUNG CITY (TW); HSIEN TING WANG, TAICHUNG CITY (TW)

(21) Appl. No.: 15/393,780

(22) Filed: Dec. 29, 2016

(30) Foreign Application Priority Data
Apr. 6, 2016 (TW) 105204710

(51) Int. Cl. B23K 26/00; B41M 5/00; B41J 2/435; B23K 26/362

(52) U.S. Cl. CPC B23K 26/0096; B23K 26/362; B41M 5/0058; B41J 2/435

(57) ABSTRACT

The present invention is aimed to design an invented portable laser marking apparatus with a mini size body, which includes several modules received in a single body for providing improved utility. That is, the present invention includes a laser control module, a marking module, a plug-in computer module, and a power supply module. All modules are easily assembled in the apparatus to become a portable single mini body, which can then be provided with a panel thereon. Therefore, by use of the single mini apparatus according to the present invention, users can operate the laser marking apparatus easily and obtain the design effect of the invention.

### BACKGROUND OF THE INVENTION

Galvanometric scanner of marking is a key assembly of laser carving or marking system, which is consisted of a laser source, and an optical, mechanical, electrical, and programing design. By use of various laser source, it can be used in different micro marking or carving processing that is better from prior mechanical carving or chemical engraving process. The processing of Galvanometric scanner of marking will be more efficient and flexible. Under using coherent lighting of high density energy, it can work either on metal or non-metal material object to mark permanent figures or words thereon. The traditional marking system is consisted of several separated means, as shown in FIG. 1, including a laser source producer (4), a marking controller (5), a computer (6), and a power supplier (7). In use, each means is independently put on a large working table, which is huge and heavy and is difficult to be moved. And because the known marking apparatus is consisted of several independent units that would not be controlled easily for user. Hence, the known design is not utilized and should be improved.

### SUMMARY OF THE INVENTION

The present invention is aimed to design an invented portable laser marking apparatus with a mini size body, which includes several modules received in a single body for providing improved utility. That is, the present invention includes a laser control module, a marking module, a plug-in computer module, and a power supply module. All modules are easily assembled in the apparatus to become a single mini body, which is then provided with a panel thereon. Therefore, by use of the single mini apparatus according to the present invention, users can operate the laser marking apparatus easily and obtain the design effect of the invention. Now, accompanying with drawings, the character and structure of the present invention will be disclosed as following.

### BRIEF DESCRIPTION OF THE DRAWINGS

FIG. 1 is a diagram chart of a traditional marking system.

FIG. 2 is a diagram chart of a portable laser marking apparatus according to the present invention.

FIG. 3 is a perspective view showing the portable laser marking apparatus according to the present invention.

FIG. 4 is an exploded view of FIG. 3

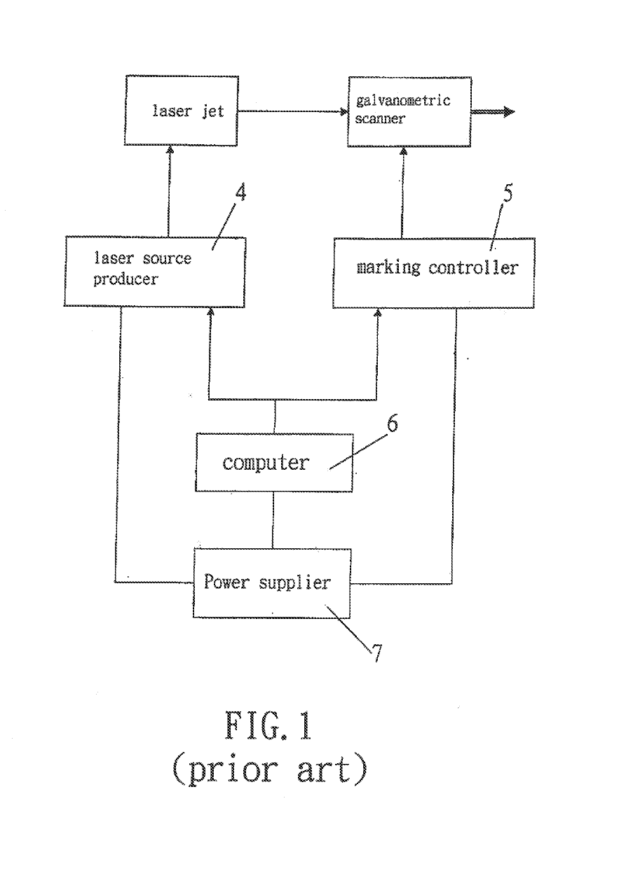

### DETAILED DESCRIPTION OF THE PREFERRED EMBODIMENT

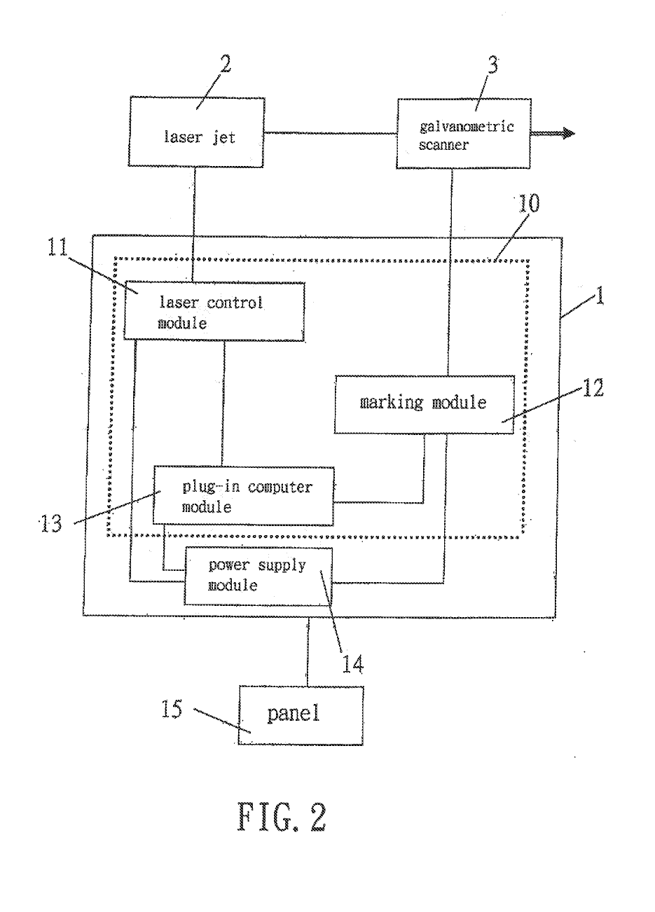

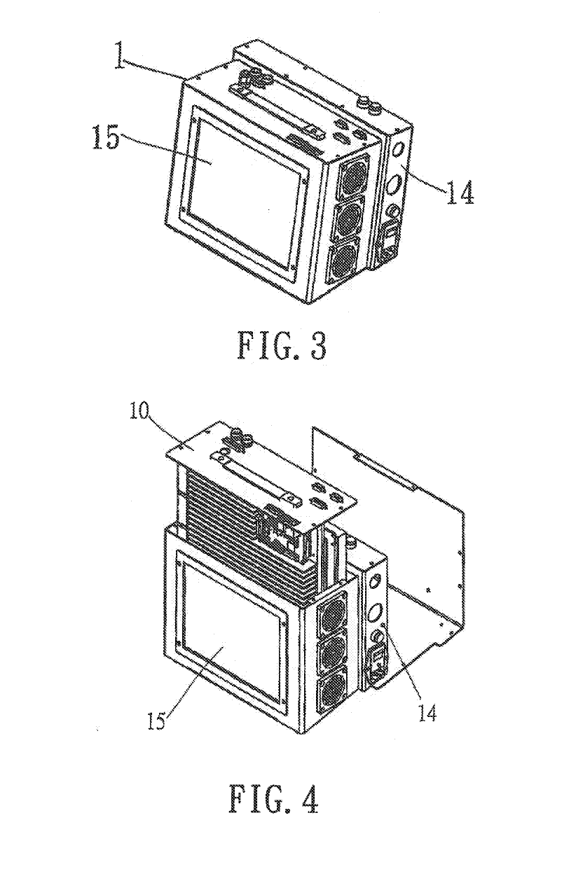

Please refer to FIGS. 2 to 4. The present invention is aimed to design an invented a portable laser marking apparatus which can overcome the drawbacks mentioned in prior art. The invention mainly provides a mini size apparatus (1), which includes a main control module (10) consisted of a laser control module (11), a marking module (12), and a plug-in computer module (13), and a power supply module (14). The laser control module (11) is to control the laser function of a laser jet (2). The marking module (12) is to control a laser source and a galvanometric scanner (3). The plug-in computer module (13) can control the CPU of the whole necessary software of the system. The power module (14) is to provide the power for the apparatus (1). Since all means are designed as a module type, they are easily assembled in the apparatus (1) to become a single mini unit with perfect electrical connection. Wherein, the computer module (13) controls the action of the laser control module (11) and the marking module (12) to process the accurate marking or carving. A panel (15) is also provided on a side of the apparatus (1) for utilizing the direct processing and watching to users.

According to the present invention, it can be found that the manufacturing of the present apparatus (1) will be easily by just assembly of each module to become a small size and light weight single body, and is therefore portable. This will be more effective in processing type of small amount of diversity. Above all, the present can obtain utility and economic value in no doubt. It can be directly used easily and portably without an external computer and other independent means, that all modules can be dismantled for maintenance conveniently to gain obvious improvement. Thus, it is to be understood that the present invention is allowable.

What is claimed is:

1. A portable laser marking apparatus including a laser control module, a marking module, a plug-in computer module, and a power supply module, wherein
the laser control module being to control the laser function of a laser jet;
the marking module being to control a laser source and a galvanometric scanner;
the plug-in computer module being to control the CPU of the whole necessary software of the system, and controlling the action of the laser control module and the marking module to process accurate marking or carving;
the power module being to provide the power for the apparatus; and
all said modules being capable of assembled in the apparatus to become a single mini unit with perfect electrical connection.

2. The portable laser marking apparatus as claimed in claim 1, wherein laser control module, the marking module, and the plug-in computer module are assembled as a main control module.

3. The portable laser marking apparatus as claimed in claim 1, wherein a panel is provided on one side of the apparatus.
